(19) United States
(12) Patent Application Publication
(10) Pub. No.: US 2002/0109979 A1
(43) Pub. Date: Aug. 15, 2002

(54) Apparatus for light directed chemical synthesis

(76) Inventor: David P. Dumas, San Diego, CA (US)

Correspondence Address: CAMPBELL & FLORES LLP, 4370 LA JOLLA VILLAGE DRIVE, 7TH FLOOR, SAN DIEGO, CA, 92122, US

(21) Appl. No.: 10/033,096

(22) Filed: Oct. 25, 2001

Related U.S. Application Data
(60) Provisional application No. 60/244,084, filed on Oct. 27, 2000.

(51) Int. Cl. F21V 9/14

(52) U.S. Cl. 362/19; 362/259

(57) ABSTRACT

The invention provides an apparatus for chemical synthesis comprising a light source, for example, a laser light source; a means for dispensing a chemical reagent onto the solid support; a means for splitting light emanating from the light source into two or more split beams of light; a means for polarizing the beams of light; a means for collimating the polarized light; a ¼-wave plate disposed between the collimating means and the solid support; a means for focusing the polarized light onto the solid support; and a photodetector array.

This application claims the benefit of priority of U.S. Provisional application serial No. 60/244,084, filed Oct. 27, 2000, the entire contents of which is incorporated herein by reference.

### FIELD OF THE INVENTION

The invention relates generally to the field of chemical synthesis and more specifically to methods and an apparatus for light directed chemical synthesis.

### BACKGROUND OF THE INVENTION

Diverse chemical populations have multiple applications in drug discovery, agricultural biotechnology, genomics, and the like. The synthesis of these chemicals has given rise to a variety of combinatorial methods. In general, these methods involve millimole and micromole quantities of reagents and expensive liquid handling instrumentation. Higher density formats, where nanomole, picomole, and femtomole quantities of reagents are used, have been described using photolithography to activate photocleavable elements on the nascent end of an oligonucleotide or peptide to expose a chemically reactive functionality. This method makes use of the photolithographic technology developed for the semiconductor industry including the use of projection masks. Each projection mask is used to cast a shadow on the surface where oligonucleotides or peptide synthesis is being carried out. The remaining exposed areas are irradiated by light, which results in chemical activation of photolabile protecting groups. The resulting exposed reactive functionalities are then used to couple another chemical unit, which is also protected by a photolabile-protecting group. By repeating such steps in the same or other areas of the support and repeating varying chemical treatments, numerous differing chemical chain compounds are synthesized in a confined space on a single support.

While photolithography is an elegant technique for the production of high-density arrays of oligonucleotides and peptides, it suffers from the constraint that costly masks must be produced for each step of the process. For example, the production of a library of 50-mer oligonucleotides would require 200 different masks.

Recently, a maskless system has been described for the production of high density arrays of oligonucleotides using a digital micromirror device which consists of a 600×800 array of 16 mm wide micromirrors, which are individually controlled to project light at discrete locations on the surface of a chip (Singh-Gasson et al. Nature Biotechnol. 17:974 (1999)). While this method allows the use of computer generated virtual masks, the number of steps are limited by the number of mirrors in the array. For instance, a micromirror array containing 2 million elements would allow for the production of oligonucleotides with 2 million elements, or about 50,000 genes with 40 elements each. Thus, while such methods eliminate the need for costly masks, the method does require the use of numerous micromirrors to generate a diverse library.

A CD-ROM based laser synthesis method has been described (WO9812559) with an array disc comprising a synthesis layer and a second reflective layer located below the synthesis layer. It is apparent from this arrangement that laser light must be directed from the same face as the synthesis layer. A device for light directed synthesis is minimally described in this report as a commercial CD-ROM instrument with only a moderate degree of modification, specifically the exchange of the laser diode with an external laboratory laser light. However, a commercial CD-ROM instrument, without modifications other than the light source, limits the type of chemistry and diversity of reactions that can be conducted with such an instrument as well as the ability to monitor the location and identity of specific compounds.

Thus, there exists a need for efficient and cost effective methods to synthesize diverse libraries of chemical compounds. The present invention satisfies this need and provides related advantages as well.

### SUMMARY OF THE INVENTION

The invention provides an apparatus for chemical synthesis comprising a light source, for example, a laser light source, for illuminating a portion of a solid support; a means for dispensing a chemical reagent onto the solid support, the dispensing means disposed to dispense a chemical reagent onto the solid support; a means for splitting light emanating from the light source into two or more split beams of light, the splitting means disposed between the light source and the solid support; a means for polarizing the beams of light, the polarizing means disposed between the splitting means and the solid support; a means for collimating the polarized light, the collimating means disposed between the polarizing means and the solid support; a ¼-wave plate disposed between the collimating means and the solid support; a means for focusing the polarized light onto the solid support, the focusing means disposed between the ¼-wave plate and the solid support; and a photodetector array disposed orthogonal to the polarizing means for detecting light reflected from the solid support. The invention also provides methods of chemical synthesis as well as compositions containing a plurality of chemical compounds.

### BRIEF DESCRIPTION OF THE INVENTION

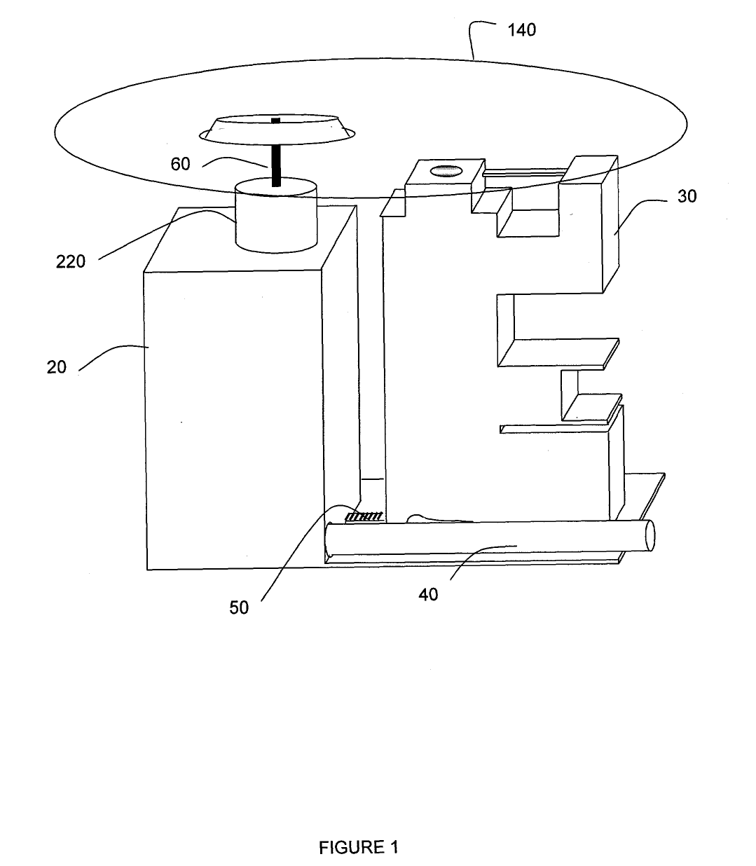

FIG. 1 shows a perspective view of a laser pattern generating device useful for chemical synthesis.

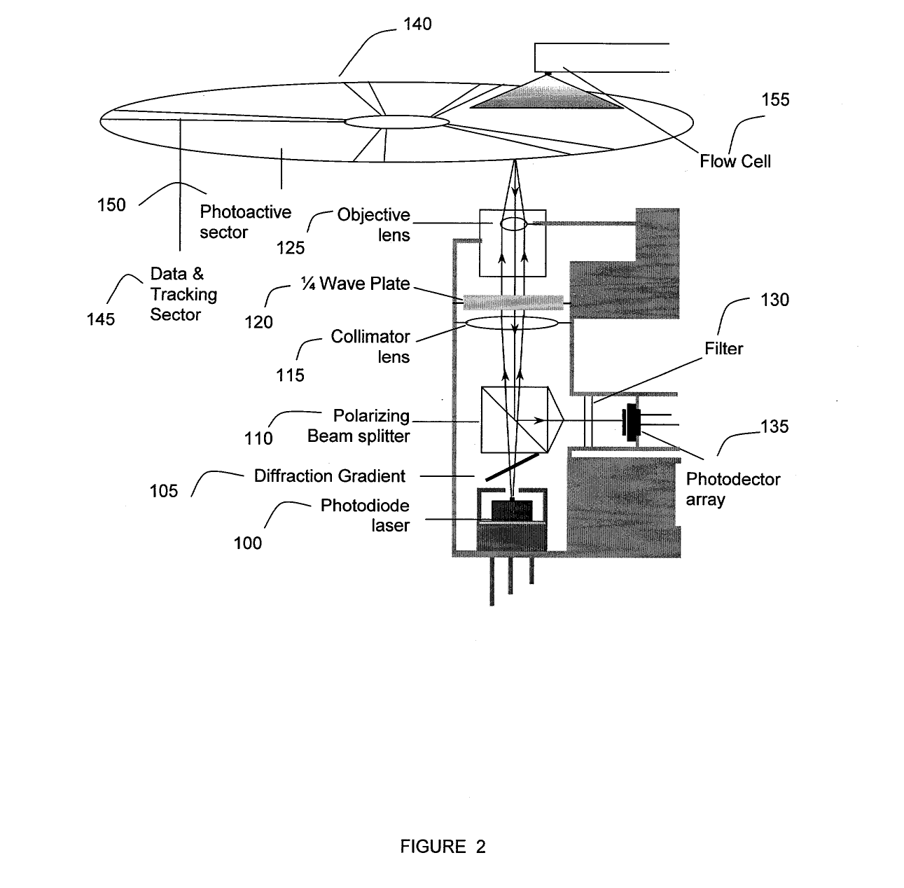

FIG. 2 shows a diagrammatic illustration of a laser pattern generating device useful for chemical synthesis.

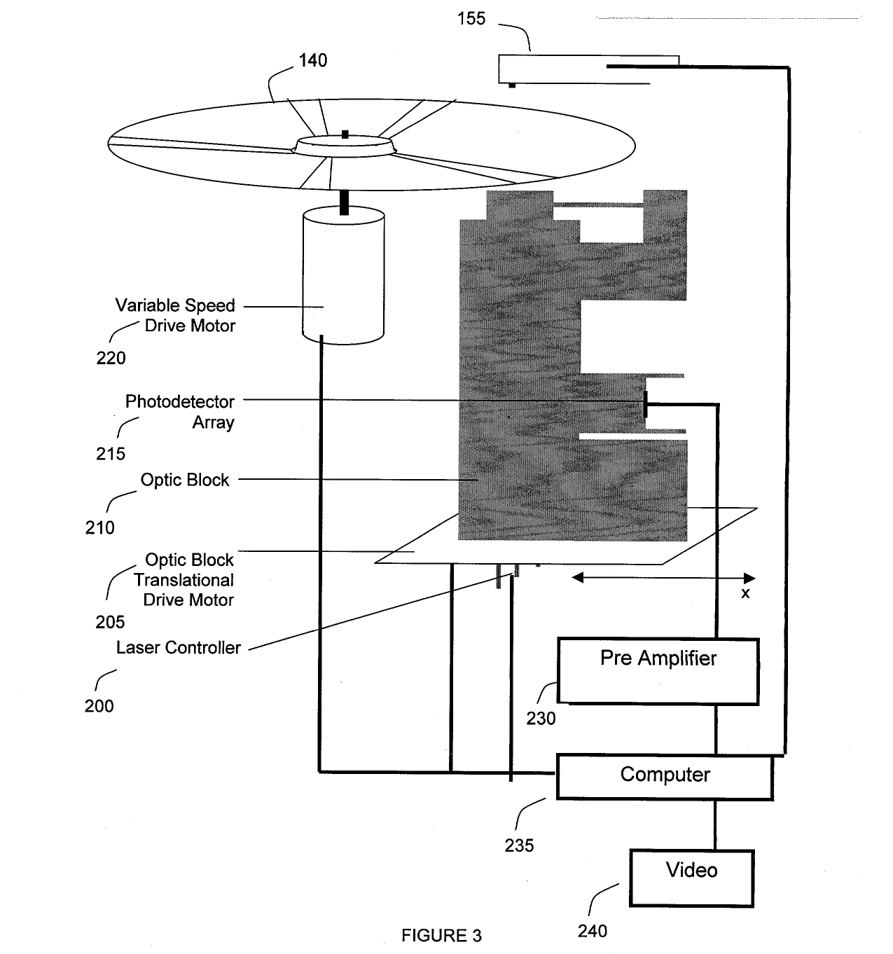

FIG. 3 shows a view of an electronic control system for a laser pattern generating device.

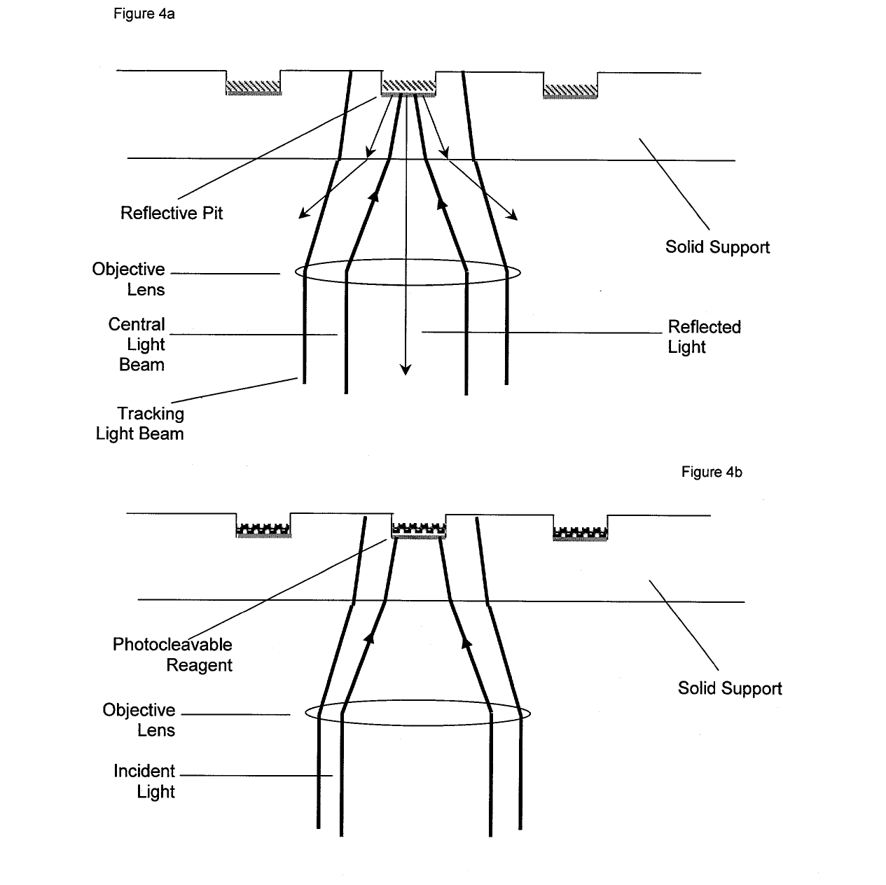

FIG. 4 shows an enlarged view of the solid support on which laser directed chemical synthesis occurs via photoactivation. FIG. 4a shows the reflection of light from a reflective data/position tracking pit.

FIG. 4b is an enlarged view of the solid support at the sector at which photocleavage takes place.

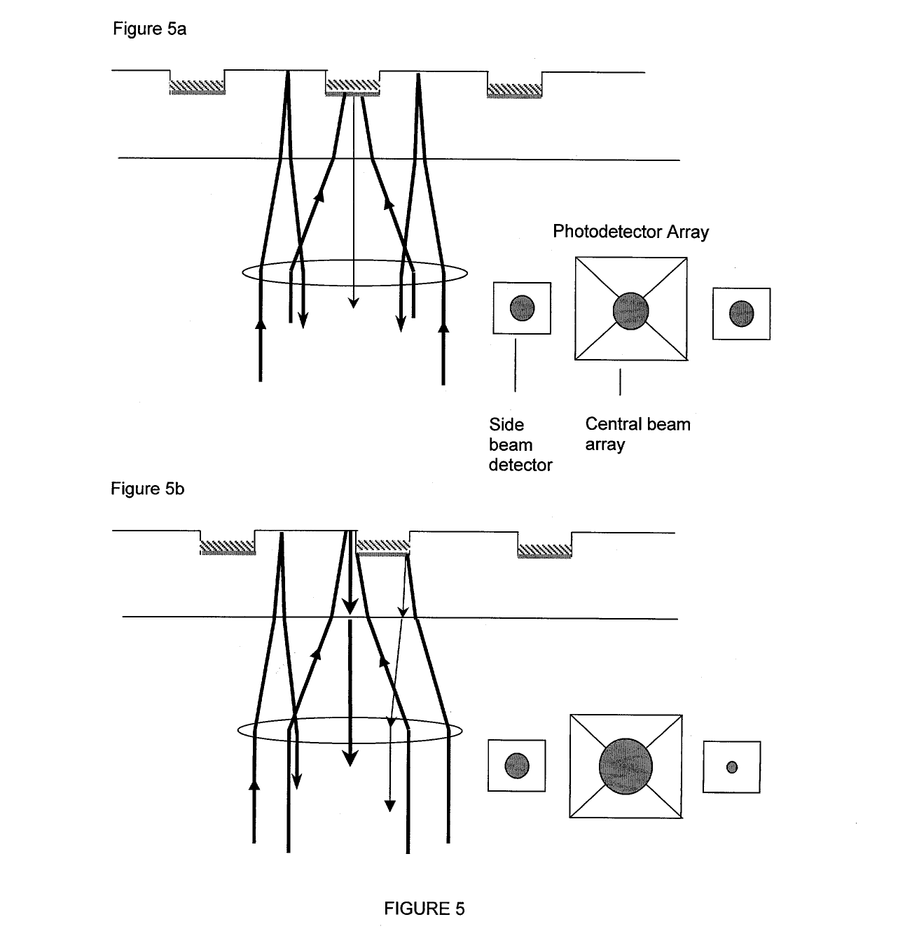

FIG. 5 shows an enlarged view of the data/position tracking system. FIG. 5a shows the data/position tracking system with the central beam on track. FIG. 5b shows the data/tracking system with the central beam off track.

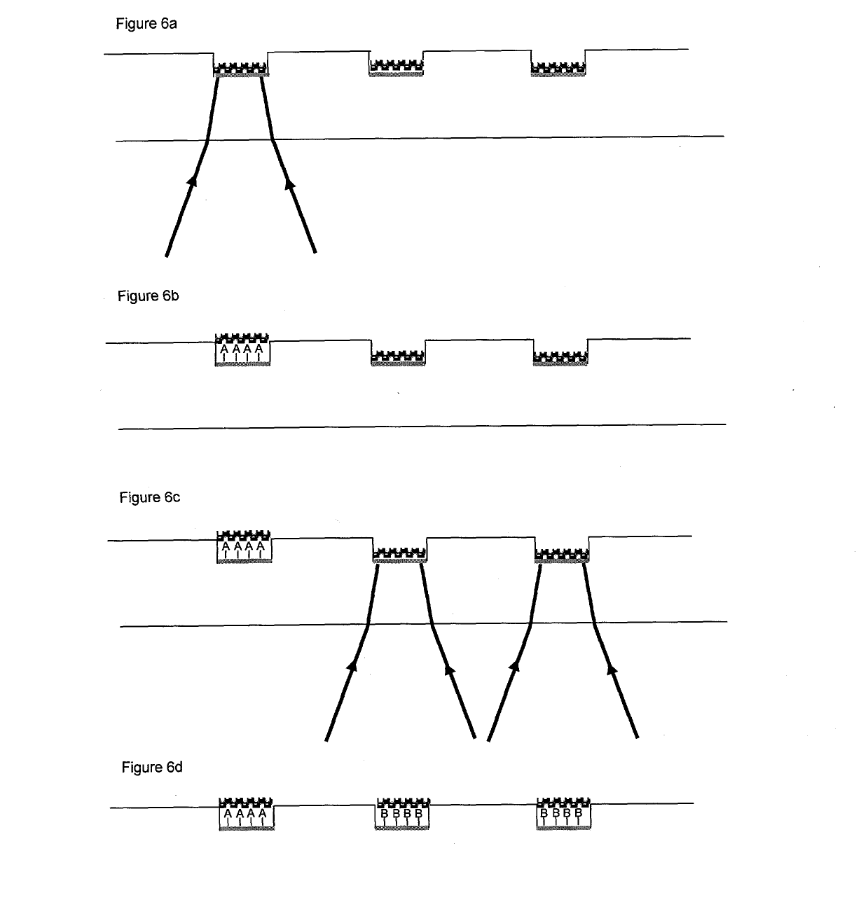

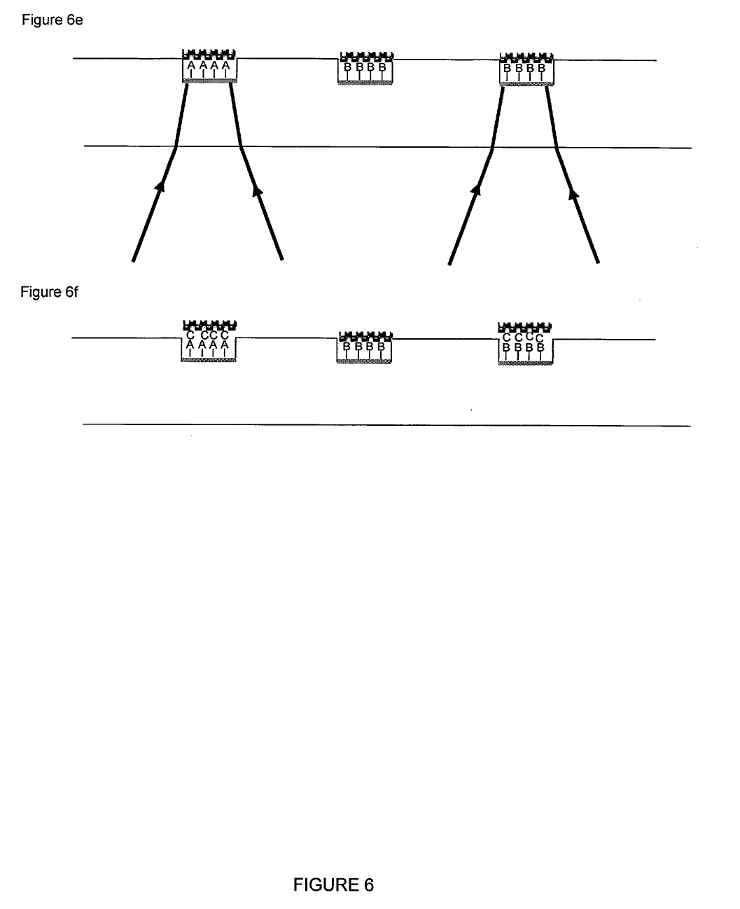

FIG. 6 shows the sequence of photocleavage at specific spatially addressed sectors followed by addition of various units on the nascent combinatorial chain (FIGS. 6a-6f).

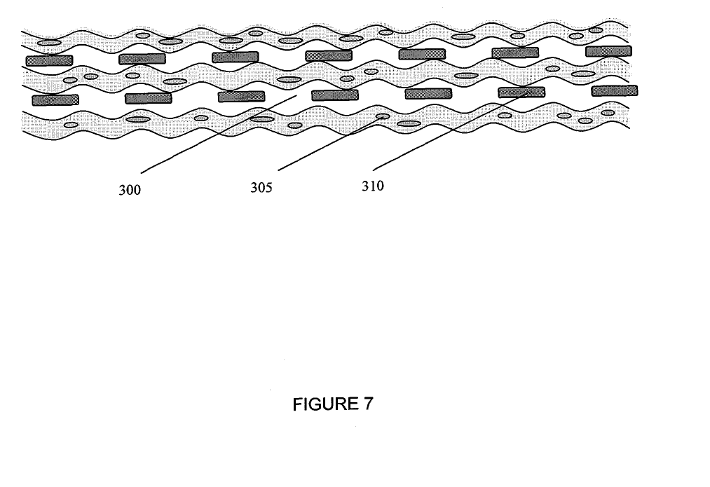

FIG. 7 shows a diagram of a method of light tracking using a modification of a DVD-R tracking mechanism.

### DETAILED DESCRIPTION OF THE INVENTION

The present invention provides an apparatus and methods for synthesizing chemical compounds such as peptides and polynucleotides on a solid support using light directed spatially addressed parallel chemical synthesis. The invention is advantageous in that a large number of illuminated elements can be generated in a serial fashion.

An invention apparatus is a device consisting of a point source of light such as that provided by a laser that can be optically connected to a polarizing beam splitter that in turn is optically connected to focusing lenses and a ¼ wave plate. This optical path causes focused light to be projected on a surface such as glass, silicon, or plastic, where photoactivation is to be carried out. Spatial direction of the light is achieved through the combined movement of the optical elements and the reaction support material. Tracking and positioning of the light spot is achieved by means of reflective elements strategically located on the surface of the support material. Light reflected from the support is directed through the optical elements of the incident light, including the ¼ wave plate. Having passed twice through the ¼ wave plate, the reflected light is now orthogonal to the incident light and is therefore reflected by the polarizing beam splitter to a photodetector. The signal is then used as input data for control software that adjusts optics and support material positioning.

By controlling the position of the incident light spot on the surface of the support material through a software application, the number of elements that can be photoactivated on the support element is limited only by the size of the light spot. Thus, an invention apparatus is essentially a light pattern generating device such as a laser pattern generating device useful for chemical synthesis. Furthermore, the invention apparatus obviates the need for photolithographic masks or micromirror projection devices. In addition, the number of elements that can be activated is not hardware limited. Thus, the invention provides a convenient and cost effective method for synthesizing a large number of chemical compounds. The invention apparatus advantageously utilizes elements of a compact disc (CD) writer to provide efficient methods of producing high density arrays of chemical compound libraries.

While an invention apparatus has many similarities in design to a CD-R device, specific and significant modifications that differ from a commercially available CD-R device are made to carry out the synthetic operation of the present invention. The wavelength of light used in the invention apparatus is shorter than that used in CD-R devices. As a result, the diffraction limited range of the collimator lens, diffraction grating for generating the three-beam tracking, the low numerical aperture of the objective lens, and the photodetector array from a CD-R are not compatible with an invention apparatus without modification. Furthermore, the optical components in a CD-R would require repositioning in order to accommodate differences in source divergence from the laser and to allow for focus control of the new laser source.

The invention provides an apparatus for illuminating a solid support. The apparatus comprises a light source, for example, a laser light source, for illuminating an area located on a solid support, wherein light emanating from the light source is of a wavelength of less than about 6.2×10⁻⁷ meters; a means for collimating light emanating from the light source, the collimating means disposed to allow the light path of the light to pass between the light source and the solid support; and a means for focusing the collimated light onto the solid support, the focusing means disposed to allow the light path of the light to pass between the collimating means and the solid support.

An invention apparatus for illuminating a solid support can further comprise a means for splitting light emanating from the light source into two or more split beams of light, the splitting means disposed to allow the light path of the light to pass between the light source and the collimating means. The apparatus can further comprise a means for polarizing the beams of light, the polarizing means disposed to allow the light path of the light to pass between the splitting means and the collimating means. The apparatus can additionally further comprise a means for rotating the plane of polarization of the collimated light, the rotating means disposed to allow the light path of the light to pass between the collimating means and the focusing means. The rotating means can be a polarization deviator, for example, a ¼-wave plate.

An invention apparatus for illuminating a solid support can further comprise a means for detecting light reflected from the solid support, the detecting means disposed to detect light reflected from the solid support through the focusing means, the rotating means, and the collimating means. The detecting means can be, for example, a photodetector array. The photodetector array can be disposed orthogonal to the polarizing means, where the rotating means is a ¼-wave plate.

An invention apparatus for illuminating a solid support can further comprise a drive mechanism for positioning the light relative to the solid support. Additionally, the apparatus can further comprise a computer apparatus for positioning the light relative to the solid support.

As used herein, a “solid support” refers to any solid medium suitable for attaching a chemical moiety and for tracking and storing information on the location and composition of attached chemical compounds. The solid support can be transparent to light, allowing activation of chemical units having photocleavable protecting groups on the side of the solid support opposite of the light source and other optics of an invention apparatus. Thus, the solid support can be, for example, an optical polymer through which light can pass. If desired, the solid support can have portions that are transparent, rather than the entire solid support being transparent. For example, the solid support can be transparent to light at discrete locations such as the pits where chemical synthesis occurs. The solid support comprises at least two types of sectors, a data and tracking sector and a photoactive sector for chemical synthesis. The solid support generally contains several data and tracking sectors interspersed between photoactive sectors, allowing more accurate positioning of the light source at discrete locations on the solid support. The nature of the data and tracking sector and the photoactive sector are described in more detail below. An apparatus of the invention can be used such that the data tracking and synthesis sector are a single layer, that is, essentially in the same plane on the solid support.

In one embodiment of the invention, the solid support is in the form of a compact disc (CD) rotatable or recordable media composed of plastic, silicon or glass. The grooves on a standard audio CD are 0.5 microns (0.5 μm) wide, and the expanding spiral of pits in this groove is separated by 1.6 microns. This gives rise to a data track that would be 4 miles long if stretched out. Thus, an invention solid support used in an invention apparatus can encode data, instructions and protocols using standard CD formatting as well as a chemical compound library synthesized in discrete locations on the photoactive sector of the solid support. The data is encoded as opticoelectric data, that is, data that can be read by an optical and/or electrical device. The chemical compounds can be synthesized along the 0.5 micron wide groove in discrete 1 micron pits. A solid support in the form of a standard sized CD contains sufficient space to synthesize at least 310×10⁶ different compounds in 1×0.5 micron pits. It is understood that, while the above-described solid support is in the format of a traditional CD with a spiral groove of pits, any format suitable for an invention apparatus disclosed herein can be used so long as the format has one or more data and tracking sectors and one or more photoactive sectors.

When using a CD format, error correction mechanisms can be used to compensate for the speed of rotation of the solid support or a difference in rotation speed between the central regions and outer regions of the solid support. For example, redundant wells containing replicates of the same chemical compounds can be synthesized as a correction mechanism. Error correction can be performed using well known alogorithms such as those used in a CD player.

In another embodiment, the solid support is molded or etched in a manner analogous to a DVD-R device (Pohlmann, Principles of Diqital Audio, pp. 363-438 McGraw-Hill, New York (2000)). The assay sector is contained within a spiral pregroove molded or etched into the surface of the solid support while the tracking sector is correlated to the land between the pregrooves (FIG. 7). Discrete synthesis wells are molded into the bottom of the pregroove. The pregroove is slightly wobbled side to side at a fixed frequency to generate a critical carrier signal for motor control, tracking, and focus when illuminated by the laser. Specific tracking information can be further encoded in the form of pits (land pre-pits) molded or etched on the land areas between the coils of the pregroove. As the laser beam follows the pregroove, the land pre-pits are contacted peripherally and create a pattern of light reflected back to the photodetector. Since the land pre-pits generate a different signal frequency than the pregroove wobble, the encoded information can be extracted and used. For example, the encoded information can be used to locate and identify a multiplicity of compounds synthesized on a solid support using an apparatus of the invention.

A modification of a DVD-R tracking mechanism useful in an apparatus invention is illustrated in more detail in FIG. 7. A pregroove 300, which can be in the form of a spiral on the solid support, is molded into the surface of the solid support with a side-to-side wobble of a certain frequency. Land pre-pits 305 are molded into the area between the pregrooves. Synthesis wells, 310, are molded into pregrooves. Such an arrangement is useful for providing tracking information on the location and identity of synthesized compounds. Thus, a tracking sector can be formatted in a method analogous to a DVD-R device, where an undulating wobble signal is molded into a groove for synchronizing a drive spindle motor using a frequency modulation (FM) encoding scheme. Due to the proximity of the tracking sites and the synthesis wells, such an arrangement can provide more accurate tracking information.

As used herein, a “light source” refers to a device that produces electromagnetic radiation of the appropriate wavelength for an invention apparatus. The light source can be, for example, a laser that emits light at a distinct wavelength. A light source can also emit a range of wavelengths, which can optionally be filtered to obtain a particular wavelength or range of wavelengths. Such a light source can be, for example, a hydrogen or deuterium lamp, a tungsten lamp, or a light emitting diode (LED). When using a light source emitting at multiple wavelengths, a filter can optionally be used to produce light of a particular wavelength or range of wavelengths. As used herein, the phrase “light emanating from a light source” refers to the light as directly emitted by the light source or to the light after passing through a filter for selecting a particular wavelength or range of wavelengths.

As used herein, a “laser light source” refers to a device capable of converting electromagnetic radiation of mixed frequencies to one or more discrete frequencies of highly amplified and coherent radiation and emitting the radiation in the form of light at a predetermined wavelength. The laser light source can be designed to emit light at a single frequency, at variable frequencies or at multiple frequencies.

A light source, for example, a laser light source, useful in an invention apparatus generally will emit light of a wavelength of less than about 6.2×10⁻⁷ meters. However, it is understood that a light source useful in an invention apparatus can emit light at any suitable wavelength of electromagnetic radiation sufficient for cleavage of a photocleavable reagent attached to a solid support. For example, the light source can emit light of about 1×10⁻⁶ meters, about 7×10⁻⁷ meters, about 6×10⁻⁷ meters, about 5×10⁻⁷ meters, about 4×10⁻⁷ meters, about 3.5×10⁻⁷ meters, about 3.4×10⁻⁷ meters, about 3.3×10⁻⁷ meters, about 3.2×10⁻⁷ meters, about 3.1×10^{31 7} meters, about 3×10⁻⁷ meters, about 2.9×10⁻⁷ meters, about 2.8×10⁻⁷ meters, about 2.7×10⁻⁷ meters, about 2.6×10⁻⁷ meters, about 2.5×10⁻⁷ meters, about 2.4×10⁻⁷ meters, about 2.3×10⁻⁷ meters, about 2.2×10⁻⁷ meters, about 2.1×10⁻⁷ meters, about 2×10⁻⁷ meters, or any wavelength useful for cleaving a given photocleavable reagent.

The light source can be positioned on the side of the solid support opposite of where the chemical synthesis is carried out or on the same side as the chemical synthesis. When the chemical synthesis is carried out on the opposite side of a transparent solid support such that light passes through the solid support before illuminating a chemical compound, the light source is chosen to emit light at a wavelength or range of wavelengths so that the wavelength of light that strikes the chemical unit attached to the solid support is sufficient to perform photocleavage of the protecting groups. Thus, the light source can be chosen such that, upon passage through the solid support, light strikes the chemical compounds at about 5×10⁻⁷ meters, about 4×10⁻⁷ meters, about 3.5×10⁻⁷ meters, about 3.4×10⁻⁷ meters, about 3.3×10⁻⁷ meters, about 3.2×10⁻⁷ meters, about 3.1×10⁻⁷ meters, about 3×10⁻⁷ meters, about 2.9×10⁻⁷ meters, about 2.8×10⁻⁷ meters, about 2.7×10⁻⁷ meters, about 2.6×10⁻⁷ meters, about 2.5×10⁻⁷ meters, about 2.4×10⁻⁷ meters, about 2.3×10⁻⁷ meters, about 2.2×10⁻⁷ meters, about 2.1×10⁻⁷ meters, about 2×10⁻⁷ meters, or any wavelength useful for cleaving a given photocleavable reagent. One skilled in the art can readily determine an appropriate light source for sufficient cleavage of a particular photocleveable reagent. The light source is sufficient for cleaving a photocleavable reagent, and is generally optimal for cleavage of a photocleavable reagent.

As used herein, “means for collimating” or “collimating means” refers to a device for collimating light emanating from the light source. Collimated light emanating from a collimating means is lined up or parallel. An exemplary collimating means is a collimator lens. A collimating means can also include fiber optic cables or parabolic mirrors, or any means to produce a parallel light source. The collimating means is generally disposed to allow the light path of the light to pass between the light source and the solid support, and can be disposed between a polarizing means and a rotating means such as a polarization deviator.

As used herein, “means for focusing” or “focusing means” refers to a device for focusing collimated light onto a solid support. An exemplary focusing means is a focusing lens, for example, an objective lens, or a fiber optic cable. The focusing means is generally disposed to allow the light path of the light to pass between the collimating means and the solid support and can be disposed between the polarization deviator and the solid support. The focusing means is generally designed to focus light on a predefined area of the solid support. As used herein, the term “area,” when used in reference to a solid support, refers to the measure of a planar region of the solid support, that is, the geometric dimensions. In particular, the focusing means focuses light on the solid support of a predefined area. For example, the lens can be used to focus light on an area of about 1 μm². Generally, the area of focus is designed such that the area of focused light strikes a limited number of sites, for example, a limited number of pits containing a photocleavable blocking agent, and preferably focuses on a single pit. Similarly, the focused light preferably focuses on a single tracking and data site.

If desired, the area of focus can be varied for particular applications, for example, by varying the distance between the focusing means and the solid support. The focusing means can be varied to focus light on an area of about 0.03 m² to an area up to about the size of the solid support, depending on the wavelength of light and desired area of illumination. When focused to an area of about 1 μm², a typically sized solid support of a standard size CD allows, excluding data and tracking sectors, the synthesis of at least about 3×10⁸ different chemical compounds.

The collimating means and focusing means can be separate means such as a separate collimator lens and focusing lens. Optionally, the collimating means and focusing means can be a single means such as a fused collimator lens and focusing lens.

As used herein, “means for splitting” or “splitting means” refers to a device for splitting light emanating from the light source into two or more split beams of light. An exemplary splitting means is a diffraction gradient or diffraction grating as well as appropriately positioned fiber optic cables. A diffraction grating consists of a screen with slits spaced a few wavelengths apart. The light such as a laser light can be of a predetermined wavelength and intensity. As the beam passes through the grating, it diffracts at different angles. A splitting means is generally disposed to allow the light path of the light to pass between the light source and the collimating means.

As used herein, “means for polarizing” or “polarizing means” is a device for polarizing the beams of light split by a splitting means. An exemplary polarizing means is a polarizing beam splitter. The polarizing means is used to polarize light to be directed to the solid support. The polarizing means is generally disposed to allow the light path of the light to pass between the splitting means and the collimating means.

As used herein, “means for rotating” or “rotating means” refers to a device that changes the plane of polarization of polarized light. One such device that rotates the plane of polarization is a “polarization deviator.” An exemplary polarization deviator is a ¼-wave plate, which rotates the plane of polarization by 45°. It is understood that any device that rotates the plane of polarization can be used as a polarization deviator, so long as the polarization deviator does not rotate the plane of polarization by 90°, which would result, after passing through the polarization deviator two times, in reflected light passing through the polarizing beam splitter. A polarization deviator is generally disposed to allow the light path of the light to pass between the collimating means and the focusing means.

As used herein, “means for detecting” or “detecting means” refers to a device capable of detecting light reflected from the solid support. An exemplary detecting means is a photodetector array. The detecting means is positioned so that light reflected from the solid support can be detected. When light is passed through a polarization deviator, the detecting means is positioned such that light rotated by the polarization deviator can be detected. When the polarization deviator is a ¼-wave plate, the detecting means is generally positioned orthogonal to the polarizing beam splitter for optimal detection of the reflected light. It is understood that the detecting means can be positioned at any location so long as a sufficient amount of reflected light can be detected for use in an apparatus of the invention, and is preferably positioned for optimal detection of light reflected from the solid support.

An invention apparatus for illuminating a solid support can further comprise a drive mechanism for positioning the light relative to the solid support. Additionally, the apparatus can further comprise a computer apparatus for positioning the light source relative to the solid support.

The invention also provides an apparatus for illuminating a solid support comprising a light source for illuminating an area located on a solid support, wherein light emanating from the light source is of a wavelength of less than about 6.2×10⁻⁷ meters; a collimator lens disposed to allow the light path of the light to pass between the light source and the solid support for collimating the light emitted from the light source; and a focusing lens disposed to allow the light path of the light to pass between the collimator lens and the solid support for focusing the light onto the solid support. The apparatus can optionally comprise a combination of one or more of the following: a diffraction grating disposed to allow the light path of the light to pass between the light source and the collimator lens; a polarizing beam splitter disposed to allow the light path of the light to pass between the diffraction gating and the collimator lens; a polarization deviator disposed to allow the light path of the light to pass between the collimator lens and the focusing lens; a photodetector array disposed to detect light reflected from the solid support through the focusing lens, the polarization deviator, and the collimator lens; a drive mechanism for positioning light relative to the solid support; and/or a computer apparatus for positioning the light source relative to the solid support.

The invention additionally provides an apparatus for chemical synthesis. The apparatus can comprise a light source for illuminating an area located on a solid support; a means for dispensing a chemical reagent onto the solid support, the dispensing means disposed to dispense a chemical reagent onto the solid support; a means for collimating light emanating from the light source, the collimating means disposed to allow the light path of the light to pass between the light source and the solid support; and a means for focusing the collimated light onto the solid support, the focusing means disposed to allow the light path of the light to pass between the collimating means and the solid support. The light source can emit light of a wavelength of less than about 6.2×10⁻⁷ meters. The apparatus can optionally comprise one or more combinations of the following: a splitting means disposed to allow the light path of the light to pass between the light source and the collimating means; a polarizing means disposed to allow the light path of the light to pass between the splitting means and the collimating means; a polarization deviator disposed to allow the light path of the light to pass between the collimating means and the focusing means; a detecting means disposed to detect light reflected from the solid support through the focusing means; a drive mechanism for positioning the light relative to the solid support; and/or a computer apparatus for positioning the light source relative to the solid support.

As used herein, “means for dispensing” or “dispensing means” refers to a device that can deliver a chemical reagent to at least a portion of a solid support. Exemplary dispensing means include a flow cell and a reservoir. A flow cell allows a chemical reagent to be dispersed onto a solid support, for example, by pumping a chemical reagent from a reservoir. The flow cell can be designed, for example, to dispense a chemical reagent such as the photoprotected chemical units disclosed herein onto the surface of the solid support as a flow of liquid or a spray or by spudding.

Alternatively, a dispensing means can be a reservoir containing a chemical reagent in which the solid support is immersed. The solid support can be immersed in the reservoir manually or using a robotic arm. When immersing the solid support in a reservoir, the reservoir can be conveniently positioned adjacent to or in the vicinity of the illuminating chamber of an invention synthesis apparatus, particularly when using a robotic arm to immerse the solid support. Alternatively, the reservoir can be separated from an invention apparatus, particularly for manual dispersion of chemical units onto a solid support, either by immersion or spraying a chemical reagent manually. If desired, a separate reservoir can be used for each chemical reagent, and the separate reservoir can be used to immerse the solid support or to pump the reagent through the flow cell. The flow cell can be disposed on the side of the solid support opposite the light source and optics of an invention apparatus or on the same side of the solid support as the optics and light source. It is understood that the dispensing means can be positioned to dispense chemicals while the solid support is in the same position as the optical activation of reagents on the solid support or the solid support can be removed from the activation chamber of the apparatus for dispensing of chemicals.

The invention further provides an apparatus for chemical synthesis comprising a light source for illuminating an area located on a solid support; a flow cell disposed to dispense a chemical reagent onto the solid support; a collimator lens disposed between the light source and the solid support for collimating light emitted from the light source; and a focusing lens disposed between the collimator lens and the solid support for focusing the light onto the solid support. Light emanating from the light source can be of a wavelength of less than about 6.2×10⁻⁷ meters. An invention apparatus can optionally further comprise a combination of one or more of the following: a diffraction grating disposed to allow the light path of the light to pass between the light source and the collimator lens; a polarizing beam splitter disposed to allow the light path of the light to pass between the diffraction gating and the collimator lens; a polarization deviator disposed to allow the light path of the light to pass between the collimator lens and the focusing lens; a photodetector array disposed to detect light reflected from the solid support through the focusing lens, the polarization deviator, and the collimator lens; a drive mechanism for positioning the light relative to the solid support; and/or a computer apparatus for positioning the light relative to the solid support.

The invention additionally provides an apparatus for chemical synthesis comprising a light source for illuminating a portion of a solid support; a means for dispensing a chemical reagent onto the solid support, the dispensing means disposed to dispense a chemical reagent onto the solid support; a means for splitting light emanating from the light source into two or more split beams of light, the splitting means disposed to allow the light path of the light to pass between the light source and the solid support; a means for polarizing the beams of light, the polarizing means disposed to allow the light path of the light to pass between the splitting means and the solid support; a means for collimating the polarized light, said collimating means disposed to allow the light path of the light to pass between the polarizing means and the solid support; a ¼-wave plate disposed between the collimating means and the solid support; a means for focusing light onto the solid support, the focusing means disposed to allow the light path of the light to pass between the ¼-wave plate and the solid support; and a photodetector array disposed orthogonal to the polarizing beam splitter for detecting light reflected from the solid support.

An apparatus of the invention disclosed herein can also be used to excite selected locations in an optical memory device such as a laser disc read/write device. In commercially available laser disc read/write optical memory devices, selected locations in a matrix are heated by an excitation beam that causes the photodegradation of an organic complex embedded in the support matrix. In accordance with the present invention, incident light is directed through the device onto a data storage medium which can be a photochromic or a photocleavable fluorescent material such as crystals, composites, or chromaphores embedded or attached in a polymer matrix bringing about a photochemical reaction. As a result of this photochemical reaction, specific sectors derive fluorescent or other optical properties. Alternatively, specific sectors can be induced to lose the characteristic of fluorescence. In this fashion, the excitation light beam excites selected locations in the matrix so that coded information represented by the beam is stored in a binary format within the medium. For example, two states of fluorescence and no fluorescence can represent the binary values of “0” and “1.”

The invention provides an apparatus for controlling the projection of light in a spatially addressable fashion for light directed chemical synthesis (see FIGS. 1 and 2). FIG. 1 shows a perspective view of an exemplary apparatus of the invention. Referring to FIG. 1, a solid support is depicted as disc 140. The housing for a drive motor for rotating solid support 140 is depicted as drive housing 20. The housing for a light source and optics for directing light to solid support 140 is depicted as optics housing 30. Positioning bar 40 is used to move the optics housing along track 50 so that the light can be directed at various distances from spindle 60, which can be rotated by variable speed drive 220. A light source such as a laser light source is used to project light, which is then passed through a diffraction grating consisting of a screen with slits spaced a few wavelengths apart. The light can be of a predetermined wavelength and intensity. As the beam passes through the grating, it diffracts at different angles. When the resulting collection of diffracted light is then focused, three beams of light are generated, with an intense central beam and two side beams. The central beam is used for reading data and focusing light on a photocleavable region for chemical synthesis, and the two secondary beams are used for tracking.

The three beams of light pass through a polarization beam splitter. The emerging light is then collimated, for example, by means of a lens. The collimated light can pass through a ¼-wave plate that rotates the plane of polarization 45°. This light is then focused onto the solid support by means of a lens that is attached to a two-axis actuator and servo system for an up/down focusing and lateral tracking motion. The central light beam is focused to a desirable area suitable for tracking and synthesis purposes, for example, an approximately 1.0 μm area, at the surface of the solid support.

The solid support comprises two sectors, a data and tracking sector and a photoactive sector. The photoactive sector contains a plurality of discrete areas, generally indentations or pits, onto which photocleavable chemical units can be attached. The data and tracking sector is used to store information on the location at which chemical synthesis is carried out and to guide or track the light source to discrete areas of the solid support. The solid support can be composed of glass, silicon, plastic, and the like, or any solid medium of appropriate composition. If desired, the solid support can be composed of a transparent medium through which light can pass if chemical synthesis is conducted on the opposite side of the solid support from the light source. Exemplary production of an invention solid support is described in Example II.

In the data and tracking sector, the central light beam is focused to a predetermined area and a discrete location at the surface of the solid support. The light then strikes the solid support, passing through the solid support if transparent, on a reflective region distinguished by a series of indentations or pits. If the light source is on the opposite side of the solid support as the pits, these pits appear as elevated regions ¼ wavelength high from the direction of the light beam (see FIG. 4a). Reflected light from these pits is 90° out of phase from the incident light and thus causes destructive interference. Thus, if the light strikes the pit, the amount of light reflected is diminished. Light reflected from the region outside of the pit is not diminished in intensity as a result of destructive interference and thus passes back into the focusing lenas such as an objective lens. The reflected light then passes through the ¼ wave plate again, where it is now polarized orthogonal to the incident light. As a result, it is reflected by the beam splitter and focused onto a photodetector array (see FIG. 2). Optionally, a filter can be disposed between the beam splitter and the photodetector array to filter the reflected light onto a photodiode of the photodetector array.

An exemplary invention apparatus is depicted in FIG. 2. Referring to FIG. 2, a laser light source is depicted as photodiode laser 100. Light is emitted from the photodiode laser through diffraction gradient or diffraction grating 105, where light is split into multiple beams. The split beams are polarized by polarizaing beam splitter 110. The polarized light is collimated by collimator lens 115. The collimated light passes through ¼-wave plate 120, resulting in rotation of the polarized light. The rotated polarized light passes through objective lens 125 so that the light is focused on solid support 140. The solid support contains two sectors, data and tracking sectors 145 and photoactive sectors 150. When light strikes a data and tracking sector, light is reflected from the solid support, back through objective lens 125, ¼-wave plate 120, collimator lens 115, and polarizing beam splitter 110, where the reflected light is deflected through filter 130 to photodetector array 135. Flow cell 155 is disposed to dispense chemical reagents onto solid support 140.

Although the above embodiment is described using an optical device containing lenses and is positioned as an optical unit relative to the solid support, it is understood that any combination of lenses, mirrors, and/or fiber optic cables can be used in an invention apparatus in any appropriate order so long as light can be directed to particular locations on the solid support sufficient for chemical synthesis and/or data tracking. Furthermore, it is understood that any of the collimating means, focusing means, splitting means, polarizing means, rotating means, and/or detecting means can be positioned relative to other means so long as the path of light passes through the means in a manner sufficient to illuminate a solid support for chemical synthesis and/or data tracking.

In one embodiment of an invention apparatus, the apparatus is encased in a dried argon filled chamber in order to facilitate chemical synthesis and obviate oxidation and undesirable side reactions. The photodiode laser can be used to generate light at a particular wavelength. As the light passes through the optical grade polymer layer, the light is refracted to a more focused beam. The index of refraction of air is 1.0, while the typical index of refraction for optical grade polymers is about 1.55. Light incident on the optical polymer surface is refracted at a greater angle into the surface. As described above, one skilled in the art can readily determine an appropriate light source for sufficient photocleavage for chemical synthesis by measuring the cleavage efficiency for a particular chemical unit by varying the wavelength or range of wavelengths emanating from the light source.

The apparatus can be conveniently used to direct and catalog chemical synthesis at discrete locations on the solid support. For example, for data tracking, the signal detected on the photodetector array can be converted to a binary code, where “1” is interpreted as a change in light intensity and “0” is interpreted as unchanged intensity. Thus, the focusing of light onto a data sector of the solid support results in deciphering of binary encoded tracking and positioning information. The data sectors are therefore read in a fashion essentially identical to an audio laser disk. The resulting reflected signal is used to navigate the light so that light is directed to discrete locations on the solid support.

For chemical synthesis, the polarized light can also strike a photoactive sector of the solid support. In these photoactive sectors, light directed chemical synthesis is carried out on the surface of the solid support. The surface of the support is provided with attached chemical units with photolabile protecting groups. By incrementally advancing the light beam across the solid support, either by movement of the solid support and/or by movement of the optics, a support having multiple scan lines of deprotected chemical units can be generated. The solid support can be simultaneously or sequentially contacted with chemical compounds to optionally add chemical units to sites of deprotected chemical units. The added chemical units can also be protected by photolabile groups.

Control of the spatial coordinates on the solid support of the light beam directed deprotection of chemical units is achieved by regulating the emission from the light source. Any means can be used to regulate emission from the light source, for example, employing a shutter to block the beam when desired or by causing a pulse of light via electronic control. Any means for regulating the light source or pulsating the beam is useful in applications of the invention. The optical components of the device are an adaptation of a writeable laser disc drive such as is described by Pohlmann (Pohlmann, Principles of Digital Audio, McGraw-Hill, New York (2000)).

A more detailed view of the electrical design of an embodiment of an invention appratus is shown in FIG. 3. The photodetector array is used to convert the light signal into a radio frequency (Rf) signal. The Rf signal from the photodiode is amplified (via a pre amplifier) and decoded prior to processing by a computer apparatus such as a micro computer. The computer apparatus can be interfaced with an output device, such as the video output device depicted in FIG. 3, or can optionally be interfaced with other output devices suitable for recording data, if desired, including recordable media such as a floppy disk, ZIP disk, writable CD, and the like. The computer apparatus can be used to control, via a software application, the movement of the optic block, drive motor, focusing means, tracking, and/or light source power. For example, as depicted in FIG. 3, the computer apparatus can be interfaced with a laser controller to regulate the intensity and/or wavelength of light from a laser light source. The computer apparatus can also be interfaced with an optic block translational drive motor, which can be used to position the optics such that light is focused at a discrete location on the solid support. The computer apparatus can additionally be interfaced with a variable speed drive motor such as that depicted in FIG. 3 to regulate the speed of rotation and positioning of the solid support relative to the optic block.

Referring to FIG. 3, photodetector array 215 detects light reflected from solid support 140, where the signal is converted to a radiofrequency signal and amplified through pre amplifier 230 and decoded prior to processing by computer apparatus 235. Computer apparatus 235 is interfaced with an output device such as video monitor 240. Computer apparatus 235 is also interfaced with laser controller 200. Laser controller 200 is connected to optic block translational drive motor 205, which is connected to optic block 210. Computer apparatus 235 is also interfaced with optic block translational motor drive 205, allowing positioning of the optic block relative to the solid support. Computer apparatus 235 is also interfaced with variable speed drive motor 220, allowing control of the speed of rotation and positioning of specific locations on the solid support relative to optic block 210. Computer apparatus 235 is also interfaced with flow cell 155, allowing control and coordination of the dispensing of chemicals on a particular area of the solid support at a particular time. The computer control allows for variable speed control of the drive motor for positioning and rotating the solid support for synthesis, transverse movement of the optic block, control of the laser power and pulsing, alignment of the optical path, and capture of data from the detectors.

In addition to controlling the relative position of the optics and the solid support, the computer apparatus can also be used to regulate the light source. As described above, the intensity and wavelength of the light can be regulated. Furthermore, whether the light is striking the surface of the solid support can also be regulated. Control of the spatial coordinates of the light beam at a discrete location of the solid support for deprotection of the chemical units in the photoactive sector can be achieved by employing a shutter to block the light beam from striking the surface of the solid support or by causing a pulse of light through electronic control. Any means for pulsating the light beam can be used in an invention apparatus. Control of pulsation of the light can be conveniently regulated by a computer apparatus interfaced with a light source including, for example, a laser controller (see FIG. 3).

Although the above described invention apparatuses are preferably interfaced with a computer apparatus for controlling the relative position of the solid support and the optics of the apparatus, it is understood that an invention apparatus for illuminating a solid support and chemical synthesis can be operated manually, if desired.

FIG. 4a shows details of the surface of the solid support in a reflective data sector. When light strikes a pit, the reflected intensity is diminished as a result of destructive interference, while light that strikes regions outside a pit is reflected at the same intensity (see FIG. 5a). As a result, intense side tracking beams are reflected from either side of the pit. When, as shown in FIG. 4b, the light strikes a pit in a photoactive sector of the solid support containing a photocleavable reagent, incident light can cleave photocleavable protective groups attached to chemical compounds in the pit. Thus, light can be used as a tracking mechanism or as an activating mechanism during chemical synthesis.

The method by which the tracking system is used to focus light on a particular sector of the solid support is shown in FIG. 5. The three beams are conveyed to the support surface through a focusing lens such as an objective lens. The central beam strikes the pit track, while the two tracking beams are aligned to either side of the central beam. During proper tracking, as shown in FIG. 5a, the tracking beams strike the area of the support between the pit tracks and is reflected through the objective lens, ¼ wave plate, and polarizing beam splitter onto the photodetector array. The tracking beams strike two separate photodiodes mounted to either side of the main four-quadrant photodiode. If tracking is precisely aligned, the difference between the tracking signals is zero. If the three light beams drift to either side of the pit track (FIG. 5b), the amount of light reflected from the tracking beams varies as one of the beams encounters more pit area, creating a difference signal in the photodiodes. To correct for tracking errors, a correction voltage is applied to an actuator on the focusing lens, for example, an objective lens, so that the main light spot is again centered as in FIG. 5a. Although the above described tracking system uses three beams of light, it is understood that since a splitting means is optional in an invention apparatus, that a single beam, or any number of desirable beams, can also be used for tracking purposes in an invention apparatus.

The steps for the synthesis of spatially addressed combinatorial libraries are shown in FIG. 6. Light is directed on specific sectors of the solid support, resulting in photocleavage of the protecting group, depicted in the pits of FIG. 6a. Accordingly, the pits of the solid support in a photocleavable sector contain chemical moieities suitable for attachment of a photocleavable protecting group and chemical units to be attached during synthesis. The unprotected chemical moieties are then contacted with a reactive chemical unit (designated “A” in FIG. 6b), which also has a photosensitive protecting group, to chemically link the reactive chemical unit “A” to the unprotected chemical moiety attached to the solid support. A second round of light cleavage can be performed to expose the same sectors of the solid support or other sectors as depicted in FIG. 6c. A second chemical unit having a photosensitive protecting group (designated “B” in FIG. 6d) is then coupled to these newly exposed sectors. Additional rounds of photocleavage can be performed at specific positions on the solid support (FIG. 6e) followed by coupling of chemical units (designated “C” in FIG. 6f). Accordingly, discrete positions on the solid support can be selectively activated by photocleavage and coupled with specific chemical units, resulting in directed synthesis, where the composition of the synthesized chemical compounds at each discrete position is known. The remaining photocleavable protecting groups can be removed by illumination of the entire solid support. Alternatively, if desired, the terminal chemical unit added as the last step of synthesis at a particular location can be a chemical unit lacking a photoprotective group.

As used herein, the term “unit,” when used in reference to a chemical compound, means a chemical molecule that can be linked together with other such molecules to form a chemical compound. A chemical unit can be any chemical molecule having at least one reactive functional group capable of being linked to a functional group on a second chemical unit. For example, the chemical unit can be any organic molecule, which can be chemically synthesized or is a natural product. It is understood that chemical units can be linked in any desired combination or order, for example, a subsequent chemical group added at a location on the solid support can be the same as the previously attached chemical unit or different. As used herein, a different chemical unit is one that differs by at least one atom from another chemical unit or is a stereoisomer or regioisomer. Exemplary reactive functional groups include reactive functionalities such as amines, carboxylates, thiols, hydroxy groups, and the like. It is understood that a chemical unit can include any chemically reactive group useful for synthesis using an invention apparatus. Chemical units useful for synthesizing peptide or oligonucleotide libraries include amino acids or nucleotides, respectively, or derivatives thereof. For light activated chemical synthesis, the chemical units will generally contain a photocleavable protective group that prevents chemical reaction with a reactive functionality prior to activation via photocleavage.

As used herein, the term “polypeptide” refers to a peptide, polypeptide or protein of two or more amino acids. A polypeptide can also be modified by naturally occurring modifications such as post-translational modifications, including phosphorylation, lipidation, prenylation, sulfation, hydroxylation, acetylation, addition of carbohydrate, addition of prosthetic groups or cofactors, formation of disulfide bonds, proteolysis, assembly into macromolecular complexes, and the like.

A modification of a peptide can also include non-naturally occurring derivatives, analogues and functional mimetics thereof generated by chemical synthesis. Derivatives can include chemical modifications of the polypeptide such as alkylation, acylation, carbamylation, iodination, or any modification that derivatizes the polypeptide. Such derivatized molecules include, for example, those molecules in which free amino groups have been derivatized to form amine hydrochlorides, p-toluene sulfonyl groups, carbobenzoxy groups, t-butyloxycarbonyl groups, chloroacetyl groups, acetyl groups, or formyl groups. Free carboxyl groups can be derivatized to form salts, amides, methyl and ethyl esters or other types of esters or hydrazides. Free hydroxyl groups can be derivatized to form esters, O-acyl, or O-alkyl derivatives. The imidazole nitrogen of histidine can be derivatized to form N-alkylhistidine. Also included as derivatives or analogues are those polypeptides which contain one or more naturally occurring amino acid derivatives of the twenty standard amino acids, for example, 4-hydroxyproline, 5-hydroxylysine, 3-methylhistidine, homoserine, ornithine or carboxyglutamate, and can include amino acids that are not linked by peptide bonds.

As used herein, the term “nucleic acid” or “oligonucleotide” means a polynucleotide such as deoxyribonucleic acid (DNA) or ribonucleic acid (RNA). A nucleotide incorporated into an oligonucleotide can be naturally occurring nucleotide or non-naturally occurring nucleotides, including derivatives thereof such as phosphoramidates and the like. Such derivatized molecules include analogs of adenosine, substituted adenosines, ethenoadenosine, guanosine, substituted guanosines, inosine, substituted inosines, uridine, 5,6-dihydrouridine, substituted uridines, cytodine, substituted cytodines, thymidine, substituted thymidines, and the like. Derivatized molecules also include glycosylated derivatives of purines, pyrimidines, imidazoles, pyridines, pyrollopyrimidines, pyrazallopyrimidine, pyroles, and other nitrogen containing heterocycles. Derivatized molecules also include modifications of the sugar group to include pentoses, substituted pentoses, deoxy-pentoses, hexoses, substituted hexoses, deoxy-hexoses, and the like.

As used herein, the term “oligosaccharide” refers to polymers of monosaccharides that can be linear or branched. Oligosaccharides include modifications of monosaccharides.

Any photolabile protecting group can be used to block a reactive functionality on a chemical unit. For example, amino groups at the ends of linkers attached to a solid support can be reacted with nitrovera-trioxycarbonyl (NVOC), a photoremovable protection group (Fodor, et. al. Science 251:767 (1991); U.S. Pat. No. 5,489,678). Other exemplary photocleavable protective groups include tris(Trimethylsilyl)silyl, 6-nitroveratryl, o-nitrobenzyl, and the like.

As used herein, a chemical compound comprises two or more chemical units covalently linked. In the case of synthesis of a peptide library on a solid support using an invention apparatus, each individual peptide is considered a chemical compound, since each peptide comprises covalently linked amino acid chemical units. Similarly, an oligonucleotide is a chemical compound of covalently linked nucleotides. The invention methods are particularly useful for synthesizing polymers, including peptides or oligonucleotides. It is understood that the invention methods can be conveniently adapted to the synthesis of any chemical compounds, including combinatorial chemical libraries, where the chemical compounds can be synthesized on solid phase (see, for example, Mendonca and Xiao, Med. Res. Rev. 19:451-462 (1999); van Maarseveen, Comb. Chem. High Throughput Screen. 1:185-214(1998); Andres et al., Comb. Chem. High Throughput Screen. 2:191-210 (1999); Sucholeiki, Mol. Divers. 4:25-30 (1998-1999); Ito and Manabe, Curr. Opin. Chem. Biol. 2:701-708 (1998); Labadie, Curr. Opin. Chem. Biol. 2:346-352 (1998); Backes and Ellman, Curr. Opin. Chem. Biol. 1:86-93 (1997); Kihlberg et al., Methods Enzymol. 289:221-245 (1997); Blackburn and Kates, Methods Enzymol. 289:175-198 (1997); Meldal, Methods Enzymol. 289:83-104 (1997); Merrifield, Methods Enzymol. 289:3-13 (1997); Thuong and Asseline, Biochimie. 67:673-684 (1985)).

Methods for peptide synthesis and the production of peptide libraries are well known to those skilled in the art (Fodor et. al., Science 251:767 (1991); Gallop et al., J. Med. Chem. 37:1233-1251 (1994); Gordon et al., J. Med. Chem. 37:1385-1401 (1994)).

The invention provides an apparatus and methods for light-directed synthesis, referring not only to photocleavage of protecting groups, but also to thermal reactions that are induced by laser irradiation, and catalyzed reactions where the catalyst is photo-generated (McGall et al., Proc. Natl. Acad. Sci. USA 93, 13555-13560 (1996); Gao et al., J. Am. Chem. Soc. 120, 12698-12699 (1998)). Reactions that either deprotect or create reactive functional groups are contemplated to be within the meaning of the phrase “light directed synthesis.” The solid support can be coated with a photosensitive material which, when exposed to laser light or another appropriate light source, is ablated or removed from a specific sector on the solid support. Exposure of the ablated solid support to acid or other reactive reagent can be used to activate or deprotect the exposed chemical functionalities. Alternatively, the surface of the support can be coated with a reagent that, upon exposure to light, results in the formation of photogenerated acids within the illuminated region. As a result, certain chemical functionalities can be deprotected through an acid catalyzed mechanism.

The invention also provides an apparatus for chemical synthesis comprising a solid support comprising a photoactive sector, the photoactive sector comprising a photocleavable protective group attached at multiple discrete locations on the solid support, and a data tracking sector, wherein the data tracking sector indicates the position of the multiple discrete locations of the photocleavable protective group; and a light source positioned for illuminating an area located on the solid support.

The invention additionally provides an apparatus for chemical synthesis comprising a solid support comprising a photoactive sector, the photoactive sector comprising a photocleavable protective group attached at multiple discrete locations on the solid support, and a data tracking sector, wherein the data tracking sector indicates the position of the multiple discrete locations of the photocleavable protective group; and a means for dispensing a chemical reagent onto the solid support, the dispensing means disposed to dispense a chemical reagent onto the solid support.

The invention further provides an apparatus for chemical synthesis comprising a means for positioning a solid support and a means for positioning a light source, wherein both means for positioning are independently moveable and wherein the means for positioning the solid support is rotated in a circular path, generally by at least about 5° or more and preferably is rotated at least 360° one or more times, that is, the solid support is spinning, for example, as a CD in an audio CD player.

Additionally, the invention provides an apparatus for illuminating a solid support, which can be used for chemical synthesis, where a single beam of light strikes a solid support, preferably a single beam of light striking a portion of the solid support, as disclosed herein.

Any of the above-described apparatuses, as with other apparatuses disclosed herein, can optionally be combined with one or more of any of the components disclosed herein, for example, a solid support, a light source, a dispensing means, a collimating means, a focusing means, a splitting means, a polarizing means, a rotating means, a detecting means, a drive mechanism for positioning light, a computer apparatus, or any other components of an invention apparatus disclosed herein.

An invention apparatus can conveniently be used to synthesize a plurality of chemical compounds on a solid support. Thus, the invention provides a method of chemical synthesis useful for synthesizing a plurality of chemical compounds. The method includes the steps of (a) focusing light onto a solid support, the solid support comprising at least one chemical unit, and can be a plurality of chemical units, comprising a photocleavable protective group dispersed in one or more discrete locations on the solid support, wherein the solid support comprises a data tracking sector for positioning the light onto a particular sector of the solid support, thereby generating a reactive chemical unit at one or more discrete positions. The method can further include step (b) performing a reaction step by contacting the solid support with a chemical unit comprising a photocleavable protective group, thereby coupling the chemical unit at one or more discrete positions on the solid support. The method can further include the step of repeating steps (a) and (b) one or more times, wherein the repeated steps are performed at the same or different positions on the solid support relative to the previous reaction step. The method can additionally further include the step of recording on the solid support the location and identity of each the reaction steps. The methods can be performed using any apparatus of the invention, as disclosed herein.

The methods of the invention can be used to synthesize any of a variety of chemical compounds. For example, a method of the invention can be used to synthesize peptide compounds or derivatives thereof, as disclosed herein. An exemplary method of peptide synthesis is described in Example I. A method of the invention can also be used to synthesize oligonucleotides or derivatives thereof, as disclosed herein. An invention method can additionally be used to synthesize combinatorial organic chemical libraries, as disclosed herein.

The invention also provides a solid support comprising a photoactive sector, the photoactive sector comprising a photocleavable protective group attached at multiple discrete locations on the solid support, and a data tracking sector, wherein the data tracking sector indicates the position of the multiple discrete locations of the photocleavable protective group. On the solid support, the data tracking and synthesis sector can be a single layer, that is, essentially in the same plane on the solid support. The solid support can be generated using any apparatus of the invention, as disclosed herein.

As used herein, “multiple discrete locations,” when used in reference to a solid support of the invention, refers to 2 or more, 3 or more, 4 or more, 5 or more, 7 or more, 10 or more, 15 or more, 20 or more, 25 or more, 30 or more, 40 or more, 50 or more, 60 or more, 70 or more, 80 or more, 90 or more, 100 or more, 120 or more, 150 or more, 200 or more, 250 or more, 500 or more, 700 or more, 1000 or more, 2000 or more, 3000 or more, 5000 or more, 1×10⁴ or more, 1×10⁵ or more, 1×10⁶ or more, 1×10⁷ or more, 1×10⁸ or more, or even 3×10⁸ or more discrete locations.

The invention further provides a solid support comprising a photoactive sector comprising a plurality of chemical compounds and a data tracking sector, wherein the data tracking sector indicates the position and identity of each of the chemical compounds. The invention solid support can comprise a plurality of chemical compounds selected from the group consisting of a peptide, oligonucleotide or organic chemical compound. An invention solid support can be in the format of a CD or DVD, for example, with a spiral arrangement of pits.

It is understood that modifications which do not substantially affect the activity of the various embodiments of this invention are also provided within the definition of the invention provided herein. Accordingly, the following examples are intended to illustrate but not limit the present invention.

### EXAMPLE I

### Synthesis of a Peptide Library

This example describes the synthesis of a peptide library using an invention apparatus for chemical synthesis.

An invention apparatus for synthesis of a chemical library is used. An optical grade polymer substrate is derivatized by ammonia gas using low pressure plasma technology in a commercially available plasma reactor. The exposed amine groups are derivatized by coupling EMOC-1-amino-hexanoic-(1′-hydroxybenzotriazole) ester (HOBt-ester)(FMOC, 9-fluorenylmethoxycarbonyl). Following removal of the FMOC group, nitroveratryloxycarbonyl (NVOC) protected β-alanine-HOBt ester is coupled to the free amine. Individual solutions of (HOBt)-activated esters of each of the amino acids naturally occurring in proteins are prepared. Side chains are protected with t-butyl ether for serine, threonine and tyrosine; t-butyl ester for aspartic acid and glutamic acid; t-butoxycarbonyl (t-Boc) for lysine, histidine, and tryptophan; 2,2,5,7,8-pentamethylchroman-6-sulfonyl (Pmc) for arginine; and trityl (Trt) for cysteine.

Spatially directed deprotection of the NVOC-protected amino group is accomplished by illumination using focused visible light irradiation of about 342 nm. The (HOBt)-activated ester of NVOC protected amino acids can be added via a flow cell or through submersion of the solid support in a reservoir of reagent. The (HOBt)-activated ester of NOVC protected amino acids are allowed to react with the entire surface of the substrate in two cycles. Following washing of the surface, a second round of illumination prepares the substrate for the addition of a second amino acid. A complete complement of pentamer peptides is generated following 100 cycles (5×20). Following the addition of the final amino acid, the substrate is uniformly irradiated to remove the terminal NVOC groups. The side chain protecting groups are removed by incubation of the substrate in a solution containing trifluoroacetic acid, ethanedithiol, anisole, and thioanisole. A dried peptide library can be stored desiccated in the refrigerator until further use.

### EXAMPLE II

### Production of a Solid Support for Chemical Synthesis

This example describes a method for production of a solid support useful for chemical synthesis using an invention apparatus.

In one embodiment, a solid support for use in an invention apparatus is produced in a manner similar to production of an audio CD. A glass master is initially made. The master includes data sectors, which are produced essentially identically to the production of an audio CD, and photoactive sectors for chemical synthesis. The photoactive sectors contain 2 μm×0.5 μm×0.11 μm pits along grooves separated by 1.6 μm. The master is written with laser etching of photoresist followed by coating with silver. Metal fathers of the master are produced by electroforming followed by the production of metal mothers from the fathers and then metal stampers from the mother plates.

The solid support is manufactured from the metal stampers by injection molding with an optical grade polymer. The production of the solid support to this point is essentially identical to the production of an audio CD except that the pits of the solid support for chemical synthesis are slightly shallower than an audio CD, which is necessary for the shorter wavelength of light used.

The sectors of the solid support to be photoactive sectors for chemical synthesis are masked, and the data and tracking sectors are coated with silver. The mask is then removed from the sectors to be used for chemical synthesis. The disc is placed in a plasma reactor with ammonia gas, which aminates the exposed optical grade polymer. The data sectors are coated with a protective acrylic plastic.

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

I claim:

1. An apparatus for illuminating a solid support, comprising:
a light source for illuminating an area located on a solid support, wherein light emanating from said light source is of a wavelength of less than about 6.2×10⁻⁷ meters;
a means for collimating said light emanating from said light source, said collimating means disposed to allow the light path of said light to pass between said light source and said solid support; and
a means for focusing said collimated light onto said solid support, said focusing means disposed to allow the path of said light to pass between said collimating means and said solid support.

2. The apparatus of claim 1, wherein said light source is a laser light source.

3. The apparatus of claim 1, further comprising a means for splitting light emanating from said light source into two or more split beams of light, said splitting means disposed to allow the path of said light to pass between said light source and said collimating means.

4. The apparatus of claim 3, further comprising a means for polarizing said beams of light, said polarizing means disposed to allow the path of said light to pass between said splitting means and said collimating means.

5. The apparatus of claim 4, further comprising a means for rotating the plane of polarization of said collimated light, said rotating means disposed to allow the path of said light to pass between said collimating means and said focusing means.

6. The apparatus of claim 5, wherein said rotating means is a ¼-wave plate.

7. The apparatus of claim 6, further comprising a means for detecting light reflected from said solid support, said detecting means disposed to detect light reflected through said focusing means, said rotating means, and said collimating means.

8. The apparatus of claim 7, wherein said detecting means is a photodetector array.

9. The apparatus of claim 8, wherein said photodetector array is disposed orthogonal to said polarizing means, wherein said rotating means is a ¼-wave plate.

10. The apparatus of claim 1, further comprising a drive mechanism for positioning said light relative to said solid support.

11. The apparatus of claim 1, further comprising a computer apparatus for positioning said light relative to said solid support.

12. An apparatus for illuminating a solid support, comprising:
a light source for illuminating an area located on a solid support, wherein said light source is a laser light source and wherein light emanating from said light source is of a wavelength of less than about 6.2×10⁻⁷ meters;
a collimator lens disposed to allow the path of said light to pass between said light source and said solid support for collimating said light emanating from said light source;
a focusing lens disposed to allow the path of said light to pass between said collimator lens and said solid support for focusing said light onto said solid support;
a diffraction grating disposed between said light source and said collimator lens, said diffraction grating including a grating for splitting light emanating from said light source into two or more split beams of light;
a polarizing beam splitter disposed to allow the path of said light to pass between said diffraction grating and said collimator lens for polarizing said beams of light;
a polarization deviator disposed to allow the path of said light to pass between said collimator lens and said focusing lens for rotating the plane of polarization of said collimated light, wherein said polarization deviator is a ¼-wave plate;
a photodetector array disposed to detect light reflected from said solid support through said focusing lens, said polarization deviator, and said collimator lens, wherein said photodetector array is disposed orthogonal to said polarizing beam splitter; and
a drive mechanism for positioning said light relative to said solid support.

13. The apparatus of claim 12, further comprising a computer apparatus for positioning said light relative to said solid support.

14. An apparatus for chemical synthesis, comprising:
a light source for illuminating an area located on a solid support, wherein said light source is a laser light source;
a means for dispensing a chemical reagent onto said solid support, said dispensing means disposed to dispense a chemical reagent onto said solid support;
a means for collimating said light emanating from said light source, said collimating means disposed to allow the path of said light to pass between said light source and said solid support; and
a means for focusing said collimated light onto said solid support, said focusing means disposed to allow the path of said light to pass between said collimating means and said solid support.

15. The apparatus of claim 14, wherein light emanating from said light source is of a wavelength of less than about 6.2×10⁻⁷ meters.

16. The apparatus of claim 14, further comprising a means for splitting light emanating from said light source into two or more split beams of light, said splitting means disposed to allow the path of said light to pass between said light source and said collimating means.

17. The apparatus of claim 16, further comprising a means for polarizing said beams of light, said polarizing means disposed to allow the path of said light to pass between said splitting means and said collimating means.

18. The apparatus of claim 17, further comprising a means for rotating the plane of polarization of said collimated light, said rotating means disposed to allow the path of said light to pass between said collimating means and said focusing means.

19. The apparatus of claim 18, wherein said rotating means is a ¼-wave plate.

20. The apparatus of claim 18, further comprising a means for detecting light reflected from said solid support, said detecting means disposed to detect light reflected through said focusing means, said rotating means, and said collimating means.

21. The apparatus of claim 20, wherein said detecting means is a photodetector array.

22. The apparatus of claim 21, wherein said photodetector array is disposed orthogonal to said polarizing means, wherein said rotating means is a ¼-wave plate.

23. The apparatus of claim 14, further comprising a drive mechanism for positioning said light relative to said solid support.

24. The apparatus of claim 14, further comprising a computer apparatus for positioning said light relative to said solid support.

25. An apparatus for chemical synthesis, comprising:
a light source for illuminating an area located on a solid support, said light source being a laser light source and said light emanating from said light source being a wavelength of less than about 6.2×10⁻⁷ meters;
a flow cell disposed to dispense a chemical reagent onto said solid support;
a collimator lens disposed to allow the path of light emanating from said light source to pass between said light source and said solid support for collimating said light;
a focusing lens disposed to allow the path of said light to pass between said collimator lens and said solid support for focusing said light onto said solid support;
a diffraction grating disposed to allow the path of said light to pass between said light source and said collimator lens, said diffraction grating including a grating for splitting light emanating from said light source into two or more split beams of light;
a polarizing beam splitter disposed to allow the path of said light to pass between said diffraction grating and said collimator lens for polarizing said beams of light;
a polarization deviator disposed to allow the path of said light to pass between said collimator lens and said focusing lens for rotating the plane of polarization of said collimated light, wherein said polarization deviator is a ¼-wave plate;
a photodetector array disposed to detect light reflected from said solid support through said focusing lens, said polarization deviator, and said collimator lens, wherein said photodetector array is disposed orthogonal to said polarizing beam splitter; and
a drive mechanism for positioning said light relative to said solid support.

26. The apparatus of claim 25, further comprising a computer apparatus for positioning said light relative to said solid support.

27. An apparatus for chemical synthesis, comprising:
a solid support comprising a photoactive sector, said photoactive sector comprising a photocleavable protective group attached at multiple discrete locations on said solid support, and a data tracking sector, wherein said data tracking sector indicates the position of said multiple discrete locations of said photocleavable protective group; and
a light source positioned for illuminating an area located on said solid support
a means for collimating said light emanating from said light source, said collimating means disposed to allow the path of said light to pass between said light source and said solid support.

28. The apparatus of claim 27, wherein said light source is a laser light source.

29. The apparatus of claim 27, further comprising a means for focusing said collimated light onto said solid support, said focusing means disposed to allow the path of said light to pass between said collimating means and said solid support.

30. The apparatus of claim 27, further comprising a means for splitting light emanating from said light source into two or more split beams of light, said splitting means disposed to allow the path of said light to pass between said light source and said collimating means.

31. The apparatus of claim 30, further comprising a means for polarizing said beams of light, said polarizing means disposed to allow the path of said light to pass between said splitting means and said collimating means.

32. The apparatus of claim 31, further comprising a means for rotating the plane of polarization of said collimated light, said rotating means disposed to allow the path of said light to pass between said collimating means and said focusing means.

33. The apparatus of claim 32, wherein said rotating means is a ¼-wave plate.

34. The apparatus of claim 32, further comprising a means for detecting light reflected from said solid support, said detecting means disposed to detect light reflected through said focusing means, said rotating means, and said collimating means.

35. The apparatus of claim 34, wherein said detecting means is a photodetector array.

36. The apparatus of claim 35, wherein said photodetector array is disposed orthogonal to said polarizing means, wherein said rotating means is a ¼-wave plate.

37. The apparatus of claim 27, further comprising a drive mechanism for positioning said light relative to said solid support.

38. The apparatus of claim 27, further comprising a computer apparatus for positioning said light relative to said solid support.

39. An apparatus for chemical synthesis, comprising:
a light source for illuminating a portion of a solid support;
a means for dispensing a chemical reagent onto said solid support, said dispensing means disposed to dispense a chemical reagent onto said solid support;
a means for splitting light emanating from said light source into two or more split beams of light, said splitting means disposed to allow the path of said light to pass between said light source and said solid support;
a means for polarizing said beams of light, said polarizing means disposed to allow the path of said light to pass between said splitting means and said solid support;
a means for collimating said polarized light, said collimating means disposed to allow the path of said light to pass between said polarizing means and said solid support;
a ¼-wave plate disposed between said collimating means and said solid support;
a means for focusing said polarized light onto said solid support, said focusing means disposed to allow the path of said light to pass between said ¼-wave plate and said solid support; and
a photodetector array disposed orthogonal to said polarizing means for detecting light reflected from said solid support.

40. The apparatus of claim 39, wherein said light source is a laser light source.

41. A method of chemical synthesis, comprising
(a) focusing light onto a solid support using the apparatus of claim 14, said solid support comprising at least one chemical unit comprising a photocleavable protective group dispersed in one or more discrete locations on said solid support, wherein said solid support comprises a data tracking sector for positioning said light onto a particular sector of said solid support, thereby generating a reactive chemical unit at one or more discrete positions.

42. The method of claim 41, further comprising the step of
(b) performing a reaction step by contacting said solid support with a chemical unit comprising a photocleavable protective group, thereby coupling said chemical unit to said reactive chemical unit at one or more discrete positions.

43. The method of claim 42, further comprising the step of
(c) repeating steps (a) and (b) one or more times, wherein step (a) is repeated at the same or different positions on said solid support relative to the previous reaction step.

44. The method of claim 41, further comprising the step of recording on the solid support the location and identity of each said reaction steps.

45. A solid support comprising a photoactive sector comprising a plurality of chemical compounds and a data tracking sector, wherein said data tracking sector indicates the position and identity of each of said chemical compounds, wherein said solid support is generated using the apparatus of claim 27.
